(19) United States
(12) Patent Application Publication
(10) Pub. No.: US 2018/0213809 A1
(43) Pub. Date: Aug. 2, 2018

(54) COMESTIBLE CONTAINING MILK SOLIDS AND METHOD OF MAKING

(71) Applicant: THE HERSHEY COMPANY, Hershey, PA (US)

(72) Inventors: Julie Emsing MANN, Annville, PA (US); Bekalu YILMA, Hershey, PA (US)

(21) Appl. No.: 15/746,674

(22) PCT Filed: Jul. 21, 2016
(86) PCT No.: PCT/US2016/043287

§ 371 Date: Jan. 22, 2018

Related U.S. Application Data
(60) Provisional application No. 62/195,923, filed on Jul. 23, 2015.

(51) Int. Cl. A23C 9/152; A23C 9/16

(52) U.S. Cl. CPC A23C 9/1526; A23C 9/16

(57) ABSTRACT

A comestible containing milk solids and method of its making includes providing a fat phase that has a fat and milk powder, providing a syrup phase that has a sweetener and a solid content between about 72% and about 88% by weight, followed by mixing the fat phase with the syrup phase in a weight ratio between 70% fat phase/30% syrup phase to 30% fat phase/70% syrup phase and forming the milk-base comestible from the mixed mass. The resulting comestibles deliver real milk in a shelf stable form in a product that has a clean taste and pleasant mouthfeel, with a non-grainy, non-mealy texture.

### CROSS REFERENCE TO RELATED APPLICATIONS

This application claims the benefit of, and priority to, U.S. App. No. 62/195,923 filed Jul. 23, 2015, which is hereby incorporated by reference in its entirety.

### FIELD

This application is directed to a comestible product and a method of making the same. More particularly, the present invention is directed to products having a high level of milk solids.

### BACKGROUND

Products formulated with proteins to achieve health benefits have become increasingly popular in sports nutrition and weight management snacking categories as well as with consumers looking for snacks that are, or which may be perceived by the consumer to be, a healthier alternative from traditional snack foods. Protein concentrates (at least 80% by weight protein) or protein isolates (at least 90% by weight protein) are often used in such products to maximize the amount of protein in a bar or other form of solid snack. Unfortunately, the use of large amounts of such protein concentrates and/or isolates found in current products can contribute to a negative taste in the product by introducing strong off-notes and to an unappealing powdery or mealy texture. Additionally, it contributes to bar hardening and adverse changes in the food product over time because the concentrated protein has a tendency to cross-link and agglomerate in the snack matrix.

Milk has long been considered a healthful, nutritious component of a good diet. While usually consumed in liquid format, in its dried powder form, milk is shelf-stable. Milk powder (dried milk) has a clean flavor and a balanced nutritional profile. However, milk powder has only 34% protein and is not used in any significant amounts in conventional protein snacks because of its lower protein content, as well as its lactose composition. Additionally it can bring a mealy texture to the final product.

### SUMMARY

Exemplary embodiments are directed to a product containing a large amount of milk solids that overcome some or all of the foregoing, and other, challenges in the art through formulations and processing techniques to provide a product that contains a large amount of milk solids, such that milk is the dominant ingredient in the product, delivers a non-grainy, non-mealy texture or mouthfeel, does not exhibit any significant changes throughout its shelf life, and can be a good or excellent source of protein, while maintaining a pleasing mouthfeel and texture.

According to one a method of making a milk-base comestible comprises providing a fat phase comprising a fat and milk powder, providing a syrup phase comprising a sweetener and having a solid content between about 72% and about 88% by weight, mixing the fat phase with the syrup phase in a weight ratio between 70% fat phase/30% syrup phase to 30% fat phase/70% syrup phase, and forming the milk-base comestible from the mixed mass.

In one embodiment, a method of making a milk-base comestible comprises providing a fat phase comprising a fat that is solid when at room temperature, milk powder selected from the group consisting of whole milk powder, non-fat dry milk, yogurt powder, Greek yogurt powder, and combinations thereof, protein powder, and an emulsifier. The method further includes providing a syrup phase comprising a sweetener, a fiber syrup, and a humectant and reducing moisture in the syrup phase to reach a solid content between about 79% and about 85% by weight. The fat phase is mixed with the syrup phase in a weight ratio between 60% fat phase/40% syrup phase to 60% fat phase/40% syrup phase and the milk-base comestible is formed from the mixed mass.

In some embodiments, the comestible is formed being at least 25% by weight milk and protein powder, a total fat content of about 10% to about 20% by weight, and about 5% to about 15% glycerol or other humectant and the milk powder is present in the comestible in an amount greater than any other ingredient.

Among the advantages of exemplary embodiments is that a clean tasting shelf-stable, solid food product is provided that contains milk as the dominant ingredient.

Another advantage is that exemplary embodiments overcome the mealy or gritty textures that are found in known solid food products containing concentrated protein sources or milk powder.

Yet another advantage is that exemplary embodiments can be used to provide a high protein product having a creamy texture.

Still another advantage is that exemplary embodiments result in a product having at least one year of shelf life with little to no discernible changes in flavor, texture, or chemistry.

Other features and advantages of the present invention will be apparent from the following more detailed description of exemplary embodiments that illustrate, by way of example, the principles of the invention.

### DETAILED DESCRIPTION OF EXEMPLARY EMBODIMENTS

Exemplary embodiments are directed to a shelf stable, solid food product that contains a large amount of milk solids such that milk is the dominant ingredient of the product. That is, exemplary embodiments preferably contain a higher percentage of real milk than any other ingredient.

By real milk is meant milk solids present in a dried (e.g. powdered) form and includes whole milk powder (WMP), non-fat dry milk powder (NFDM), yogurt powder, Greek yogurt powder, and combinations thereof. Exemplary embodiments may also employ some form of protein concentrate or protein isolate, which may also be a milk product such as milk protein concentrate and milk protein isolate.

Exemplary embodiments employ the formulation of separate fat and syrup phases. In some embodiments, the syrup is cooked to drive off moisture and increase the solid content. In other embodiments, the syrup phase may be formulated directly with the desired solids content without any need for cooking or other form of moisture removal. The fat and syrup phases are combined and mixed to achieve a uniform mass that can then be formed into the final product.

The fat phase is formulated by combining fat, milk powder, and typically an emulsifier. The fat is in addition to any fat already present in the milk powder and may be any comestible fat for use in the manufacture of food products, with a preference in some embodiments for non-hydrogenated fats that are free of trans-fatty acids. The fat may be a solid or a liquid fat. Whether the fat is solid or liquid at room temperature will have a bearing on the final texture of the formed product and in some embodiments, solid fats are preferred. Exemplary fats that may be used include vegetable fats, cocoa butter and cocoa butter alternatives (e.g. cocoa butter equivalents, cocoa butter improvers, cocoa butter substitutes, cocoa butter replacers), palm oil, fractionated palm oil, coconut oil, illipe and shea nut butters, fractionated soybean or cottonseed oils, lauric fat compounds, canola oil, peanut oil, olive oil, safflower oil, and sunflower oil, and blends thereof.

The total amount of fat (i.e. milk fat, vegetable fats or any other fats) is about 8 to about 30% by weight of the total product formulation, typically in the range of about 10% to about 20% by weight fat, such as about 10%, about 11%, about 12%, about 13%, about 14%, about 15%, about 16%, about 17%, about 18%, about 19% and about 20% by weight fat, and any amount, range or sub-range between any of the foregoing.

The fat phase further includes some form of milk powder such as whole milk powder (WMP), non-fat dairy milk powder (NFDM), yogurt powder, including Greek yogurt powder, and combinations thereof. Additional milk in the form of milk protein concentrate and/or milk protein isolate may also be employed and added to the fat phase. The milk powder is at least 20% by weight of the formed comestible, such as at least 25% by weight, at least 30% by weight, or higher. The total amount of milk and protein powder together is such that the comestible is in the range of about 25% by weight to about 40% by weight of the powders, including about 25%, about 26%, about 27%, about 28%, about 29%, about 30%, about 31%, about 32%, about 33%, about 34%, about 35%, about 36%, about 37%, about 38%, about 39%, and about 40%, all by weight, and any amount, range or sub-range between any of the foregoing.

Exemplary embodiments also generally include an emulsifier in the fat phase, including lecithin, polyglycerol polyricinoleate (PGPR), ammonium phosphatide (YN), and combinations thereof, by way of example only. The emulsifier is typically present as about 0.05% by weight to about 0.6% by weight of the total product formulation, although more or less may be employed depending on the particular fat and emulsifier used.

Additional solid ingredients may be added to the fat phase, as well as any liquid ingredients that may be sensitive to the elevated heat of any cooking of the syrup phase. Exemplary additional ingredients that may be included in the fat phase include flavorings (e.g. cocoa powder, vanillin, vanilla, etc.) and nutritional supplements (e.g., probiotics, calcium, vitamins, additional minerals, omega-3 fatty acids, etc.), by way of example only.

For embodiments employing a solid fat, the fat is typically first softened or melted in the presence of the emulsifier and thereafter mixed with the milk powder and other fat phase ingredients to form a thick paste. In some embodiments, the fat phase may be refined prior to mixing with the syrup phase, which can aid in achieving a creamy texture. The fat phase may be refined to any desired level and in some embodiments is refined to less than 70 microns, such as less than 50 microns and in some embodiments to between about 20 and about 30 microns.

Separately, a syrup phase is formulated with a sweetener and one or more of a fiber, a humectant and/or a hydrocolloid. The syrup phase may or may not include added water for the initial formulation. The sweetener may be any sweetener and in some embodiments includes a combination of solid and liquid sweeteners. Exemplary sweeteners include glucose syrups, such as corn syrup, sucrose, maltodextrin, fructose, dextrose, evaporated cane juice syrup, agave syrup, tapioca syrup, brown rice syrup, coconut sugar, and may also include one or sugar alcohols such as sorbitol, mannitol, xylitol, hydrogenated starch hydrolysates (HSH), erythritol, and maltitol.

Fibers in the syrup may be syrup based or in dry powder form or some combination of the two. Exemplary fiber syrups include inulin syrup, fructo-olliggosaccharide syrup (FOS), soluble corn fiber syrup, polydextrose syrup, and combinations thereof. Exemplary dry powder fiber includes one or more of pea fiber, soy fiber, rice fiber, and additional vegetable and plant based fibers.

The syrup further includes a humectant, which may be present as glycerol although sugar alcohols may also be employed in a dual role as both sweetener and humectant and may be used alone or in combination with glycerol or other humectants, such as sorbitol. The amount of humectant may be in the range of about 5% to about 15% by weight of the product formulation.

The syrup phase optionally includes up to about 0.4% by weight of a hydrocolloid or gelling agent such as one or more of carrageenan, pectin, agar-agar, gelatin, gum arabic, locust bean gum, guar gum, xanthan, starch, maltodextrin, gum ghatti, gum karaya, gum tragacanth, dextran, konjac flour, aribinogalactan, gellan gum, furcellaran, and alginate, all by way example. Depending upon the particular hydrocolloid employed, if any, it may be desirable to first mix the hydrocolloid into the humectant prior to its introduction into the rest of the syrup.

For embodiments in which moisture is removed and solid content is increased by cooking, any water soluble additives that are not sensitive to the heat of cooking may be conveniently added to the syrup phase. If desired, additional moisture can be added in the form of added water and/or fruit juice or fruit juice concentrate.

The syrup phase may have a solid content in the range of 72 to 88% by weight solids, such as about 75% to about 85% by weight solids. The syrup may be initially formulated to the desired solid weight or may be cooked or otherwise processed to remove moisture and increase the solid content.

In embodiments that include a protein powder, such as a protein concentrate or protein isolate, the protein powder may be introduced as part of the fat phase along with the milk powder. In some embodiments, a portion of the protein powder, in some cases as much as one half or more, may be reserved and lightly mixed into the syrup phase. The syrup phase may then be allowed to rest for up to five, ten or more minutes so that the protein becomes hydrated in the syrup.

Any source of protein may be used for the protein concentrate and/or protein isolate, including, for example, concentrates and/or isolates of milk, whey, soy, pea, dairy, canola, rice, and lentil protein, with a preference for dairy proteins such as milk and/or whey.

The cooked syrup is then added to the fat phase, which is mixed until uniform. The syrup phase and fat phase are preferably added in equal amounts by weight although the amounts may range up to 20% or more in either direction, (e.g. between 70% wt. fat phase and 30% wt. syrup phase to 30% wt. fat phase and 70% wt. syrup phase, such as between 60% wt. fat phase and 40% wt. syrup phase to 40% wt. fat phase and 60% wt. syrup phase).

Once a uniform mixture has been achieved, the resulting mass can be processed for final product formation, which may include one or more of slabbing, rolling, drop rolling, cutting, extruding, and molding, for example, along with a final cooling to ambient temperature. In some embodiments, inclusions may be introduced into the formulation which may occur after the fat and syrup phases have been mixed.

### EXAMPLES

The invention is further described in the context of the following examples which are presented by way of illustration, not of limitation.

### Example 1

A comestible having 10 g of protein per serving was made according to the formulation set forth in Table 1 in which the protein was a blend of non-fat dairy milk, milk protein concentrate (80% by weight protein) and whey protein isolate (90% by weight protein) powders in which the syrup and fat phases were combined in a 50/50 weight ratio.

TABLE 1

| | Weight |
|---|---|
| | % |
| Fat Phase | 50.00 |
| Milk Protein Concentrate | 10.50 |
| Whey Protein Isolate | 12.50 |
| Lecithin | 0.28 |
| Vanillin | 0.02 |
| NFDM | 15.00 |
| Fractionated Palm Oil | 9.55 |
| Calcium | 2.15 |
| Syrup Phase | 50.00 |
| Sorbitol | 3.21 |
| Glycerine | 7.85 |
| Sucrose | 14.72 |
| Carageenan | 0.21 |
| Inulin Syrup | 11.12 |
| Corn Syrup (43 DE) | 12.44 |
| Salt | 0.46 |
| Total | 100.00 |

The comestible was formed by first weighing up the ingredients of the fat phase with the fat (fractionated palm oil) and emulsifier (lecithin) melted together in a mixing bowl. The NFDM, vanillin, calcium and half of the whey protein isolate were then mixed into the melted fat/emulsifier blend to form a thick paste, having a consistency that was likened to an unrefined white chocolate mass.

Separately, for the syrup phase, the syrup ingredients were added to a kettle and heated, except that the glycerine and carageenan which were separately mixed to form a slurry. The glycerine/carageenan slurry was added back to the rest of the syrup phase ingredients after the temperature reached around 120° F. Sucrose was added in its regular form, which was dissolved without any need for pre-milling.

The syrup was then cooked to between 245 to 250° F. to reduce the solid content of the syrup to about 83% to about 84% by weight, after which it was cooled.

300 grams of syrup was weighed, into which the milk protein concentrate and the reserved whey protein isolate were added and lightly mixed, followed by a short rest period of 5 to 10 minutes for the protein to hydrate.

The syrup was then mixed with a total 300 grams of the fat phase (including the amount of protein added to the syrup first to hydrate) for a 50/50 weight ratio and blended until uniform. The resulting mass was then slabbed into a framing bar, rolled and cooled.

### Example 2

A second comestible was made consistent with the process of Example 1, but having the formulation set forth in Table 2. The protein content in this example resulted from a blend of non-fat dairy milk, whole milk power and milk protein concentrate (80% by weight protein).

TABLE 2

| | Weight |
|---|---|
| | % |
| Fat Phase | 50.00 |
| Milk Protein Concentrate | 8.50 |
| Whole Milk Powder | 17.97 |
| Lecithin | 0.15 |
| Vanillin | 0.01 |
| NFDM | 9.00 |
| Fractionated Palm Oil | 11.75 |
| Calcium | 2.62 |
| Syrup Phase | 50.00 |
| Sorbitol | 3.81 |
| Glycerine | 9.34 |
| Sucrose | 17.52 |
| Carageenan | 0.12 |
| Inulin Syrup | 6.63 |
| Corn Syrup (43 DE) | 12.31 |
| Salt | 0.27 |
| Total | 100.00 |

### Example 3

A third comestible was made consistent with the process of Example 1 and having the formulation set forth in Table 3. The protein content was a blend of non-fat dairy milk and milk protein concentrate (80% by weight protein).

TABLE 3

| | Weight |
|---|---|
| | % |
| Fat Phase | 50.00 |
| Milk Protein Concentrate | 10.05 |
| Lecithin | 0.28 |
| Vanillin | 0.02 |
| NFDM | 25.00 |
| Fractionated Palm Oil | 12.00 |
| Calcium | 2.65 |
| Syrup Phase | 50.00 |
| Sorbitol | 3.21 |
| Glycerine | 7.85 |
| Sucrose | 14.72 |
| Carageenan | 0.21 |
| Inulin Syrup | 11.12 |
| Corn Syrup (43 DE) | 12.44 |
| Salt | 0.45 |
| Total | 100.00 |

### Example 4

A fourth comestible was made consistent with the process of Example 1 and having the formulation set forth in Table 4. The protein content was a blend of non-fat dairy milk and milk protein isolate that was 88% by weight protein.

TABLE 4

| | Weight |
|---|---|
| | % |
| Fat Phase | 50.00 |
| Milk Protein Isolate | 7.00 |
| Whole Milk Powder | 24.25 |
| Lecithin | 0.15 |
| Vanillin | 0.01 |
| Natural Cocoa Powder | 3.75 |
| Fractionated Palm Oil | 12.21 |
| Calcium | 2.63 |
| Syrup Phase | 50.00 |
| Sorbitol | 3.81 |
| Glycerine | 9.34 |
| Sucrose | 13.62 |
| Carageenan | 0.12 |
| Inulin Syrup | 6.64 |
| Corn Syrup (43 DE) | 16.20 |
| Salt | 0.27 |
| Total | 100.00 |

### Example 5

A fifth comestible was made consistent with the process of Example 1 and having the formulation set forth in Table 5. The protein content was a blend of non-fat dairy milk, Greek yogurt powder and milk protein concentrate (80% by weight protein).

TABLE 5

| | Weight |
|---|---|
| | % |
| Fat Phase | 50.00 |
| Milk protein concentrate | 10.75 |
| Greek yogurt powder | 10.00 |
| Lecithin | 0.24 |
| Vanillin | 0.01 |
| NFDM | 15.50 |
| Fractionated Palm Oil | 10.00 |
| Calcium | 3.50 |
| Syrup Phase | 50.00 |
| Sorbitol | 3.11 |
| Glycerine | 8.30 |
| Sucrose | 14.83 |
| Carageenan | 0.24 |
| Soluble Corn Fiber | 12.60 |
| Corn Syrup (43 DE) | 10.40 |
| Salt | 0.52 |
| Total | 100.00 |

### Example 6

Another comestible was made having the formulation set forth in Table 6 using about a 50/50 by weight blend of fat to syrup phase.

TABLE 6

| | Weight |
|---|---|
| | % |
| Fat Phase | 50.8 |
| Greek yogurt powder | 32.2 |
| Coconut oil | 18.1 |
| Lecithin | 0.5 |
| Syrup Phase | 49.2 |
| Agave syrup | 16.3 |
| Inulin | 21.2 |
| Glycerine | 6.2 |
| Flavor | 1.2 |
| Fruit crumb | 4.3 |
| Total | 100.0 |

As with the other examples, the comestible was formed by first weighing up the ingredients of the fat phase with the fat and emulsifier melted together in a mixing bowl into which the Greek yogurt powder were then mixed to form a thick paste that was refined to between 20 and 30 microns.

Separately, for the syrup phase, the syrup ingredients, with the exception of the fruit crumb, were mixed. The solids content of the syrup phase was such that cooking was not necessary and the syrup phase and fruit crumb were mixed into the fat phase in an approximately 50/50 weight ratio as reflected in Table 6 and blended until uniform. The resulting mass was then slabbed into a framing bar, rolled and cooled.

### Example 7

Another comestible was made consistent with the process of Example 6 and having the formulation set forth in Table 7, in which the comestible was formulated with an approximately 40/60 fat/syrup phase ratio.

TABLE 7

| | Weight |
|---|---|
| | % |
| Fat Phase | 40.0 |
| Greek yogurt powder | 25.3 |
| Coconut oil | 14.3 |
| Lecithin | 0.4 |
| Syrup Phase | 60.0 |
| Agave syrup | 19.8 |
| Inulin | 25.9 |
| Glycerine | 7.6 |
| Flavor | 1.5 |
| Fruit crumb | 5.2 |
| Total | 100.0 |

While the foregoing specification illustrates and describes exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of making a milk-base comestible comprising:
providing a fat phase comprising a fat and milk powder;
providing a syrup phase comprising a sweetener and having a solid content between about 72% and about 88% by weight;
mixing the fat phase with the syrup phase in a weight ratio between 70% fat phase/30% syrup phase to 30% fat phase/70% syrup phase; and
forming the milk-base comestible from the mixed mass.

2. The method of claim 1, further comprising introducing a protein powder into the syrup phase, fat phase, or both.

3. The method of claim 2, wherein the protein powder is selected from the group consisting of protein concentrate, protein isolate, and combinations thereof

4. The method of claim 1, wherein the milk powder is selected from the group consisting of whole milk powder, non-fat dry milk, yogurt powder, Greek yogurt powder, and combinations thereof.

5. The method of claim 1, wherein the fat is a solid at room temperature.

6. The method of claim 1, wherein the comestible is in the range of about 10% to about 20% by weight fat.

7. The method of claim 1, wherein the fat phase further comprises an emulsifier.

8. The method of claim 1, wherein the syrup phase further comprises a humectant, such that the comestible is between about 5% and about 15% by weight of the humectant.

9. The method of claim 8, wherein the syrup phase further comprises a fiber.

10. The method of claim 9, wherein the fiber is a fiber syrup.

11. The method of claim 8, wherein the syrup further comprises a gelling agent, such that the comestible is up to about 0.4% by weight of the gelling agent.

12. The method of claim 1, wherein the comestible is at least 20% by weight milk powder and the milk powder is present in the comestible in an amount greater than any other ingredient.

13. The method of claim 1 further comprising cooking the syrup phase to achieve the solid content between 72% and 88% by weight.

14. The method of claim 1 comprising mixing the fat phase with the syrup phase in a weight ratio between 60% fat phase/40% syrup phase to 40% fat phase/60% syrup phase.

15. The method of claim 14, comprising mixing the fat phase with the syrup phase in an amount of about 50% by weight fat phase and about 50% by weight syrup phase.

16. A method of making a milk-base comestible comprising:
providing a fat phase comprising a fat that is solid when at room temperature, milk powder selected from the group consisting of whole milk powder, non-fat dry milk, yogurt powder, Greek yogurt powder, and combinations thereof, a protein powder, and an emulsifier;
providing a syrup phase comprising a sweetener, a fiber syrup, and a humectant;
reducing moisture in the syrup phase to reach a solid content between about 79% and about 85% by weight;
mixing the fat phase with the syrup phase in a weight ratio between 60% fat phase/40% syrup phase to 40% fat phase/60% syrup phase; and
forming the milk-base comestible from the mixed mass, the comestible being at least 25% by weight milk powder and protein powder, and comprising a total fat content of about 10% to about 20% by weight, and about 5% to about 15% by weight humectant, wherein the milk powder is present in the comestible in an amount greater than any other ingredient.

17. A comestible manufactured by the method of claim 1.

18. A comestible comprising at least 20% by weight milk powder, a fat, a sweetener, and a humectant, wherein the total fat content of the comestible is about 10% to about 20% by weight, the humectant is about 5% to about 15% by weight of the comestible, and wherein the milk powder is present in the comestible in an amount greater than any other ingredient.

19. The comestible of claim 18 further comprising protein powder, wherein the comestible is between 25% and 40% by weight milk powder and protein powder.

20. The comestible of claim 19, wherein the protein powder includes dairy protein.
